(19) United States
(12) Patent Application Publication
(10) Pub. No.: US 2012/0085727 A1
(43) Pub. Date: Apr. 12, 2012

(54) Collar for high-pressure bottles and process for its construction

(75) Inventor: Giovanni Fratti, Muggia (TS) (IT)

(73) Assignee: CTS S.P.A., Chiopris-Viscone (UD) (IT)

(21) Appl. No.: 13/322,557

(22) PCT Filed: Jun. 8, 2009
(86) PCT No.: PCT/EP2009/004104

§ 371 Date: Nov. 26, 2011

(51) Int. Cl. B65D 23/12; B23P 17/04

(52) U.S. Cl. 215/386; 29/428

(57) ABSTRACT

The present invention concerns a collar (4) for high-pressure bottles (and the process for its implementation), characterized in that it is composed of two elements attachable to each other, which can be integrated in the mass (3) of the container itself, formed of composite material, metal alloy, synthetic material, resins and reinforcement fibers. The internal—extractable—element (4.2) of the nozzle (4) presents in its internal part a hexagonal through hole (9), whereas the upper part presents a thread for fixation of a valve or tap; on the upper external part there is located a thread for coupling with the external element (4.9), whereas on the lower part there is an annular seat for receiving a seal (5) in direct contact with the core (2). A similar seal (5) is provided on the external element (4.9). Between the two elements (4.2) and (4.9)—on the lower part-, the terminal of the core (2) is fixed: the assembly is then enclosed on its exterior in a plurality of wrapping layers made of reinforcement fibers and synthetic resins.

### SCOPE OF APPLICATION

The present invention concerns a collar for high-pressure bottles (and the method for its implementation), composed of different metal elements which can be stably coupled to each other, which can be integrated in the mass of the container itself which is formed of composite material, metal alloy, synthetic material, resins and reinforcement fibers.

The nozzle is composed of several elements made of metal or metal alloy, which are stably locked to each other by means of threads and/or welding and/or adhesive bonding and being united with the end of the core (liner), being fixed simultaneously on its two sides, internal and external. Such group has an external polygonal form in order to promote its integration in the mass of composite material which constitutes the bottle, avoiding the possibility of rotating about itself when it is subjected to screwing (in case of insertion of a tap or valve) and guaranteeing at the same time perfect sealing even at high pressures.

The invention is particularly useful and advantageous in the production of bottles made of composite material, of different capacities and at high pressure, on cores made either of synthetic material or of metal (sheet steel, aluminum or metal alloys).

### STATE OF THE ART

In the current state of the art, there are known—in the production of high-pressure bottles or containers, lined on the outside by several layers of reinforcement fibers and/or synthetic resins—various types of attachment collars for taps and/or safety valves.

Pressure containers are known which are produced entirely of steel or aluminum alloy, with various successive phases of hot forming of the starting material, which form the nozzle directly in the mass of the material, implementing a thread suitable for the locking of a tap or sealing valve. These techniques guarantee the impermeability of the containers to the gases or fluids contained in them, but such technical solutions are expensive, require high investments in equipment and ground, and the final product is heavy and impractical to move. Therefore, it has been believed first to overcome these problems by implementing the circumferential wrapping with reinforcement fibers and/or resins, reducing thickness of the metallic structure by approximately half; then, secondly, by implementing a circumferential wrapping in axial direction, further reducing thickness and weight of the metallic structure; finally, with a core made of non-structural thermoplastic, reinforced on the outside, with wrappings in all directions.

The first solution, although advantageous from an economic point of view, leads to a very heavy object; the other cases are compromises between production costs and reduction of weight. The last example is the most lightweight, but it has the disadvantage of being partially permeable to gas. This is unacceptable for certain types of gas, such as methane, hydrogen, helium and more generally the various toxic mixtures. The critical point of these products consists in the core and the coupling of the same between the conical nipple and the outlet. The outlet must be implemented in metallic material in order to guarantee a perfect accommodation of the threaded valve; at the interface between the plastic material and the surface of the outlet, the gas tends to penetrate and to produce with time a delamination effect with consequent escape of gas.

For overcoming such disadvantages, the method proposed by patent WO2006/034439 A2 for the construction of nozzles of high-pressure containers is known, where an internal ring of the elastic type is provided which is of the split type for permitting its dilatation. Such internal ring does not allow the insertion of a seal between the core (liner) and the nozzle material; additionally, due to being elastic, such internal ring is not blocked axially; in particular, it could fall inside the container and lose its functionality. This ring could not be of the conical type, since this geometrical shape would not promote its fixing into position, but would on the contrary increase the axial instability. The employed technique must provide at least two seals: one between the external wrapping and the body of the collar, and the other between the external wrapping of the nozzle and the internal core (liner). In addition, this system does not allow replacement of the external seal between the wrapping of the nozzle and the core of the container, since they are both integrated in the same wrapping.

Referring next to patent WO2007/079971 A1: the employed system does not allow disassembly and replacement of the seal, since the external wrapping of the nozzle is integrated in the reinforcement, which prevents the sealing ring from being removed, which would release the seat of the seal itself.

Referring to patents WO2005/0993313 A1, EP 1228862 A1 and WO 96/99142: the three proposed systems are substantially equivalent: they present the metallic structure of the nozzle integrated in the core of the container by means of melting and/or soakage of the plastic material of the core to the interior of respective cavities, provided in various manner in the metallic structure of the nozzle itself.

All these well-known systems have disadvantages connected to the cohesion between the metallic surfaces and the plastic-polymeric ones of the liner, which, when subjected to high gas pressures, tend to disintegrate with time and to let more and more gas escape through these interfaces. In addition, there is no possibility to intervene on the nozzle, for normal maintenance, without inevitably having to damage the liner as well. Also in the case of the patents WO2006/034439 A2 and WO2007/079971 A1, as already shown, ordinary maintenance of the seals for their possible replacement is not possible (the warranty of efficiency of the container is reduced with time and use).

### OBJECT OF THE INVENTION

It is therefore the object of the present invention to redress the disadvantages encountered with the known techniques, implementing a collar or nozzle for high-pressure reinforced bottles (of composite material) and a construction method which has the following characteristics:

a nozzle adapted and connectible with sealing safety equally for cores (liners) of metallic material and/or of plastic material,

an internal sealing ring of the integral, not elastic split, type, of conical type, able to contain a toroidal seal between said ring and the core of the bottle;

a sealing ring which can be conical in order to increase the adhesion of the internal and external surfaces of the core to the external surface of the ring and the internal surface of the external wrapping of the nozzle, respectively;

an internal ring which is perfectly stable in position and screwed to the external wrapping of the nozzle;

an internal shape of the sealing ring which has a hexagonal seat for facilitating its assembly and disassembly;

the external part of the nozzle which presents a polygonal (for instance an octagonal) shape, on which the reinforcement fibers with the resins are wrapped, forming an integral body, integrating it: this defines an extraordinary fastening torque for the screwing the valve or tap into the internal part of the nozzle, such torque being unloaded on the nozzle and on the external wrapping and not on the core of the bottle;

avoidance of the tensions normally placed on the end of the core, distributing them on a larger surface concerning both the internal and the external portion of the same: in the internal portion, by means of the ring in direct contact with the smooth and/or threaded, cylindrical and/or conical surface, and in the external portion by means of the nozzle body with smooth and/or threaded, cylindrical and/or conical surface.

### ESSENCE OF THE INVENTION

The objects of the invention are achieved according to the characteristics of the main claim and/or of any other claim presented in this patent, by implementing a collar for high-pressure bottles—lined with several layers of reinforcement fibers and resins—and the exemplification of the respective construction method.

The implementation of a collar (or attachable elements made of metallic material) is proposed, which is suitable to be coupled with a core (liner, consisting of thin steel sheet or of light alloy of aluminum or plastic material), forming in this manner an outlet incorporated in the external synthetic reinforcement lining mass, in which successively a gas supply valve is received, avoiding losses through the connection interface between the core and the outlet itself.

In a first solution, the internal part of the outlet consists of a ring of tubular cylindrical shape of metallic material and has a first upper internal part threaded and adapted to receive a valve by screwing; the second part is obviously perforated and shaped (in transversal section) as a hexagon, so that it can be extracted with a hexagonal wrench for its maintenance; being screwed to the second element external of the outlet. In the first external part of the ring, there is a thread for the screwing to the second element of the outlet. In a lower portion, the external surface is perfectly smooth and interrupted by an annular groove suitable to receive a toroidal seal; this surface will adhere to the core of the bottle (of metallic or plastic sheet).

The external body of the outlet, also made of metal, or the second element forming the outlet is formed as follows: in the first upper internal part, there is a thread for screwing to the internal ring; in the second part, there is a cylindrical recess with a smooth surface for receiving the core of the bottle, interrupted by an annular groove for receiving an annular seal. This internal part ends in a connection towards the outside, accompanying the core, and in a successive and ample broadening of thinned material, thus forming a broad support surface on the core itself. In the external part of this element, a first simply cylindrical portion is provided which broadens forming a configuration with polygonal (for instance octagonal) section with protruding teeth which then tapers until it has reached the final part of the element.

This solution allows complete extraction of the internal ring element for performing the maintenance or control and/or the replacement of the internal seal.

The method for fixing the outlet to the core of the bottle is as follows: firstly the external toroidal seal is positioned within the suitable seat of the external element of the outlet; said external element is brought closer to the core of the bottle and made to adhere perfectly; the other internal seal is inserted in the suitable seat of the internal ring element; the same is screwed completely to the external body of the outlet, enclosing the core between the attachable elements; finally the external reinforcement wrapping with several layers of fibers and resins is carried out, enclosing—in particular—the external part with greater over-thickness in proximity to the external element of the outlet, covering the polygonal shape as well.

The product obtained in this manner is technically perfect: an outlet which avoids delamination of the gas also at high pressure between the core of the bottle and the contact walls of the outlet itself, also due to the two toroidal seals, internal and external to the core itself, and the ample thickness of the wrapping with reinforcement fibers and resins in proximity to the attachment area of the outlet to the core of the bottle.

In a second solution, the internal part of the outlet is different in its lower internal shape: instead of terminating cylindrically, it is broadened, increasing in diameter and following the connection of the core of the bottle, presenting two seats for receiving the seal (one in the cylindrical section and the other, which has a larger diameter, in the final section for surface contact). In this case, the seal on the outside of the core is not envisaged; as for the rest, it is identical with the first case illustrated above. This solution cannot be disassembled; therefore, its maintenance is not possible; it is recommended in case bottles are constructed with junction of the core along the longitudinal part of the bottle itself.

It follows that the attachment of the outlet to the core is different from the preceding example, since the internal element of the outlet, equipped with two toroidal seals, is inserted from the internal part of the bottle (and can no longer be pulled out) and is made to adhere to the terminal part of the core; it is then screwed on the outside to the second external portion of the outlet, which has no seats for the sealing. Once the two attachable elements of the outlet are locked, the terminal part of the core of the bottle is simultaneously enclosed between them. Then the ample external wrapping of the entire attachment zone of the outlet and of the entire bottle is carried out with reinforcement fibers and resins.

Another variation of the present invention concerns the possibility of providing on the terminal portion of the core of the bottle, whether it is made of metal or of plastics, and provided with sufficient thickness, an internal and an external thread. The external one is used for screwing to it the external element of the outlet (in this manner, another sealing is not necessary); whereas the internal one is used for screwing to it (after insertion in the suitable seat of the internal seal) the internal ring forming the outlet. In this manner, the terminal part of the core of the bottle is enclosed between the two elements of the outlet; then the external wrapping (of ample thickness) with the reinforcement fibers and/or synthetic resin is performed, covering completely the joining region of the nozzle and the core.

Another variation of the present invention consists in the fact that the two threads—external and internal—of the terminal part of the core of the bottle are of the conical type, thus corresponding also to those of the external ring element and of the internal ring element forming the outlet. This technical particularity improves the tightness and the time-efficiency of the bottle.

The invention achieves the proposed objects which are: overcoming the disadvantages known in this field; guaranteeing tightness over time by means of employing a modular nozzle of two metallic parts which enclose the terminal portion of the core of the bottle, avoiding delamination of gas even at high pressure; allowing implementation of high-pressure bottles while significantly lowering their weight, thus facilitating their handling and their transport; permitting, in some solutions described, interchangeability of the internal ring part, facilitating maintenance and making it possible to replace the internal sealing.

### EXPLANATION OF THE DRAWINGS

Four solutions according to the present invention are represented for preferential exemplary purposes, though not limiting, in the five enclosed figures, wherein:

FIG. 1 shows, in a sectional front view, a high-pressure bottle consisting of a core made of sheet metal or lined with plastic and/or reinforced with fibers and resins, pointing out the region of the collar or modular nozzle equipped with only one sealing in the internal part and an extractable ring component;

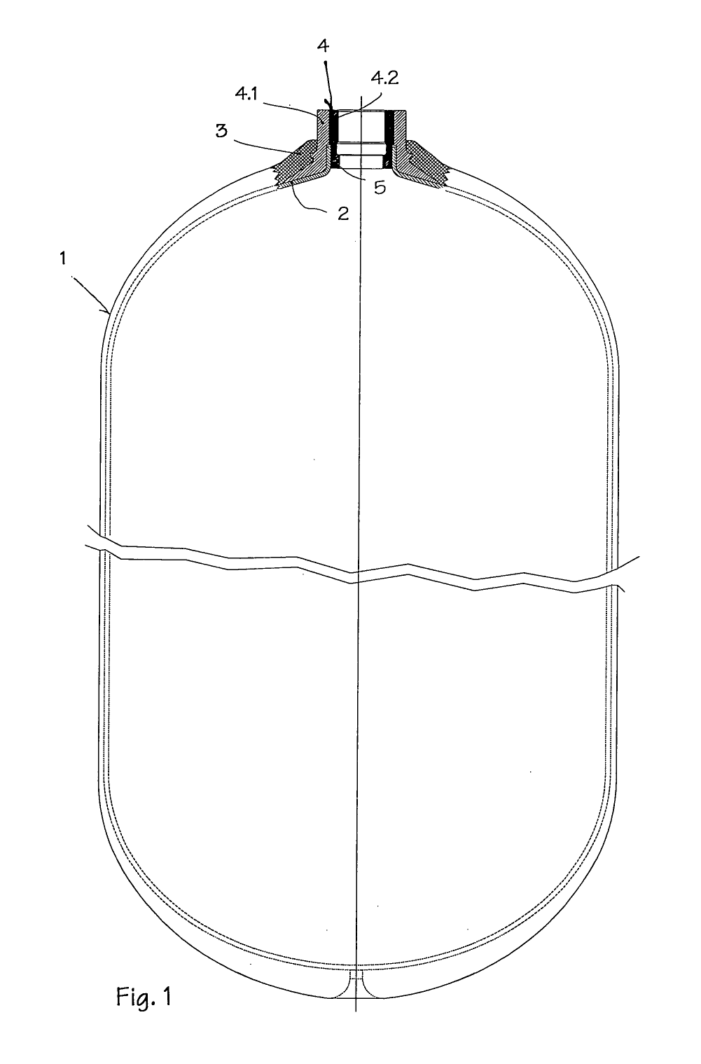

FIG. 2 shows, in cross-sectional and plan view, the nozzle with the internal attachment element carrying a seal of the annular and extractable type, having two sealing seals (one on the internal side and one on the external side of the terminal part of the core);

FIG. 3 shows, in cross-sectional and plan view, the modular nozzle provided with an internal element with two sealing seals, of the type which cannot be extracted, and inserted in the bottle only during the construction phase;

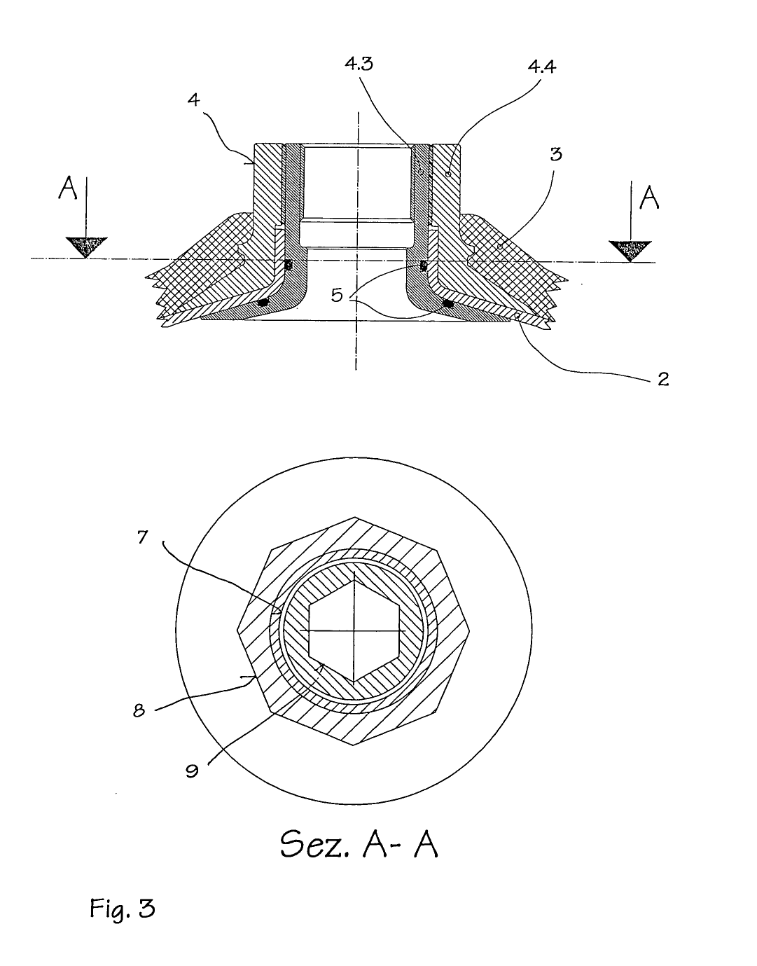

FIG. 4 shows, in cross-sectional and plan view, the modular nozzle with an extractable internal ring element, with the terminal part of the core of the bottle threaded both on the outside and on the inside;

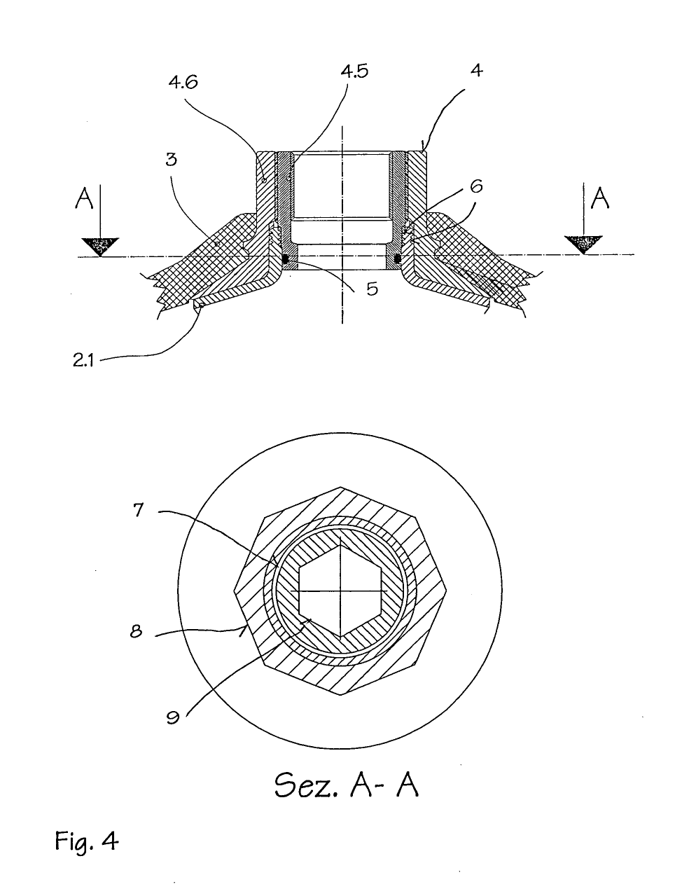

FIG. 5 shows, in cross-sectional and plan view, the modular nozzle similar to the preceding figure, where however the external and internal threads of the terminal portion of the core are of the conical type, and having analogous threads on the respective surfaces of the two nozzle components.

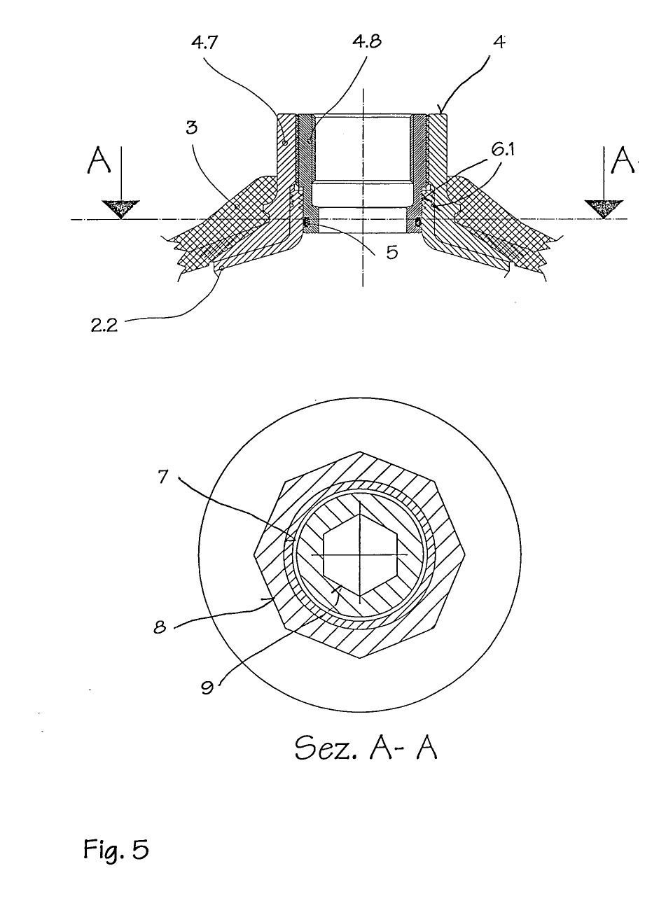

As can be seen from the various figures, the collar or nozzle for high-pressure bottles is applied to the terminal part of the core (2) of the bottle (1), made of sheet steel or light alloy or plastics or synthetic material, reinforced externally with a plurality of layers made of composite material (3) as reinforcement fibers imbibed in synthetic resins which will integrate the nozzle (4) in the mass forming the high-pressure bottle.

The invention is represented in the construction solutions of the various types of nozzle (4), formed of different elements which can be combined with each other, in order to guarantee tightness and avoid delamination of the (pressure) gas contained in the bottles themselves.

First of all, the nozzle (4) is composed of two metallic parts worked with precision, an external part (4.1) and an internal part (4.2), coaxial and both ring shaped, which can be screwed and united to each other due to the internal thread of the external element and the external thread of the internal annular element. Between these parts, there remains a lower space suitable to contain, enclose and lock the terminal part of the core (liner) (2) of the bottle.

On the upper internal part of the internal ring (4.2), there is provided a thread for blocking a valve or tap for supply of the gas contained in the bottle (1). In addition, on the lower external part of the ring element (4.2), there is provided at least one annular seat (7) for receiving at least one toroidal seal (5) which is brought in direct contact with the internal part of the core of the bottle (2). This ring is removable and can be unscrewed as required for performing the maintenance or the replacement of the seal (5).

For facilitating the locking of this ring to the external body (4.1) of the nozzle and/or its removal, a formed seat—for instance of hexagonal shape (9)—is provided in the central perforated part so that a torque can be applied by insertion of a suitable wrench. For the same reason, the external element of the nozzle has on its upper external portion, on the external surface, a double flat seat, placed in opposition, parallel and coaxial for insertion of a wrench and then achieving greater efficiency in the action of locking or unlocking these two elements which form the nozzle. In the central lower part of the external element (4.1), there is provided a polygonal (for instance octagonal) configuration (8) whose purpose it is to provide more surface resistant to axial rotation after wrapping with several layers of reinforcement fibers and resins.

The relative procedure of implementing the collar and of fixing it to the core of the bottle (made of metal or plastic) comprises: insertion of the seal (5) into the seat (7) of the internal element (4.2); then the same is positioned on the internal terminal portion of the core (2) of the bottle (1); then the external element (4.1) of the nozzle (4) is vigorously screwed to the internal element (4.2), thus enclosing the core of the bottle; once the locking has taken place, the external wrapping with several layers of reinforcement fibers and resins is carried out, forming a substantial thickness of the composite material (3) which covers and integrates the external shaped part (8).

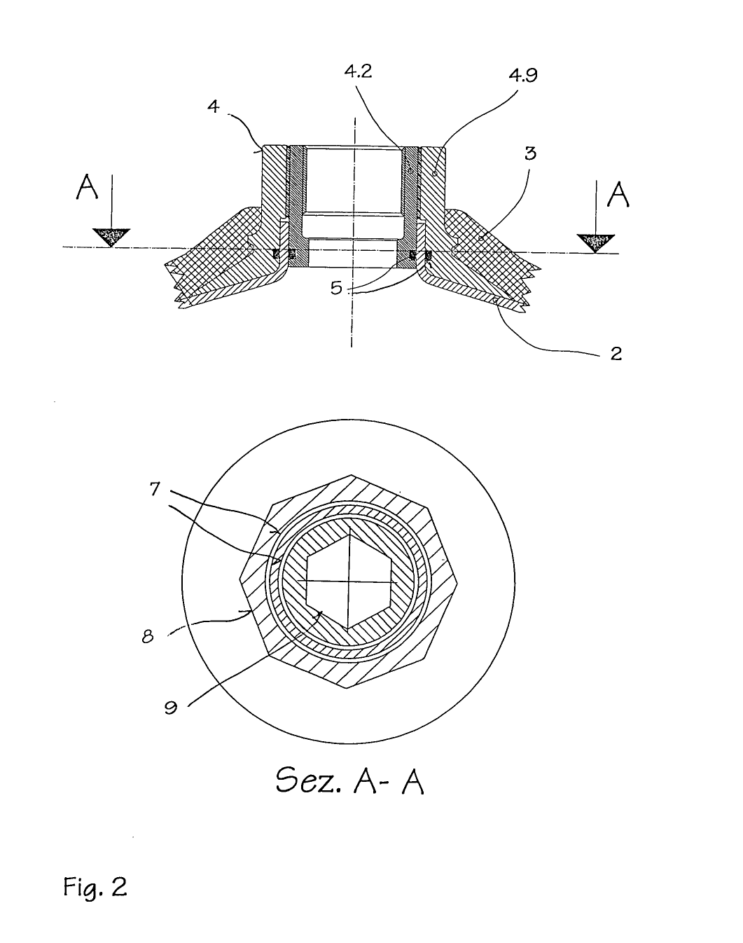

After this embodiment solution, in FIG. 2 there is illustrated an embodiment in which alternatively the possibility is envisaged of providing, on the external element (4.9) of the nozzle, an annular seat (7) on the internal portion, placed in opposition to the one formed in the internal element (4.2) of the nozzle, in order to be able to insert an annular seal (5) externally to the core (2) as well. In this case as well, the internal component (4.2) of the nozzle is of the type which can be extracted for maintenance.

In the third representation, a solution different from the preceding ones is illustrated, in which the internal element (4.3) of the nozzle is not extractable and can be applied only from the internal part of the core of the bottle (in the case of bottles of substantial length where welding of the two parts forming the core is envisaged). The lower part of said element (4.3) broadens in a circular manner; therefore it cannot be extracted through the opening of the nozzle. It has two consecutive annular seats (7) on the face in contact with the core (2) of the bottle, one on the cylindrical portion and the other on the inclined portion of said core. In this case, the external element (4.4) is identical with the element (4.1) in the first representation.

The fourth representation is a variation of the first representation with the only difference existing in the terminal part of the core (2); it presents, both in the internal portion and in the external one, a thread (6) analogously in the respective portions of the two elements forming the nozzle (4), the internal portion (4.5) and the external portion (4.6).

Finally, the fifth representation is similar to the preceding one with the only difference that the threads—both on the terminal sections of the core (6.1) and in the two components of the nozzle, internal (4.8) and external (4.7)—are of the conical type, like those commonly used in the hydraulic sector. In this case, the more the elements are tightened in play between them (elements of the nozzle and the core of the bottle), the more the parts tighten themselves, guaranteeing maximum tightness between the parts and avoiding in this manner the delamination of the gas contained.

Naturally, the invention is not limited to the examples of embodiment described above, departing from which other forms and other embodiments can be provided, and the details of implementation can in any case vary without departing from the essence of the invention as it is disclosed and claimed in the following.

The invention claimed is:

1. A collar for high-pressure bottles, preferably implemented with an internal core (2, 2.1, 2.2) made of a sheet of metallic or plastic material and lined on the outside with several layers of reinforcement fibers and resins, the collar comprising:
an internal part (4.2, 4.5, 4.8) and an external part (4.1, 4.4, 4.6, 4.7, 4.9) configured to be attached to each other forming a nozzle (4), the internal part (4.2, 4.5, 4.8) being in the form of a cylindrical ring, whose upper portion has an external thread for being screwed to the external part (4.1, 4.4, 4.6, 4.7, 4.9) and an internal thread for being screwed to a supply valve or tap, the external part (4.1, 4.4, 4.6, 4.7, 4.9), having a first upper portion in the form of a cylindrical ring and terminating at a lower end in a broadened manner in a circular inclined and connected flange, which has on an upper internal portion a thread configured to be screwed to the thread formed on the internal part (4.2, 4.5, 4.8);
wherein the external part (4.1, 4.4, 4.6, 4.7, 4.9) and the internal part (4.2, 4.5, 4.8) are formed of metallic material;
wherein the first upper portion of the external part (4.1, 4.4, 4.6, 4.7, 4.9) and the internal part (4.2, 4.5, 4.8), which are both in the form of a cylindrical ring, define, when coupling of the internal and external parts has taken place, a substantially cylindrical space sufficient for enclosing, containing and locking between them the core (2, 2.1, 2.2) of a bottle (1);
wherein at least one of the external part (4.1, 4.4, 4.6, 4.7, 4.9) and the internal part (4.2, 4.5, 4.8) has at least one seat or annular groove (7) on a surface in contact with the core (2, 2.1, 2.2) of the bottle (1), suitable for receiving a toroidal seal (5); and
wherein the external part (4.1, 4.4, 4.6, 4.7, 4.9) is further locked to the core (2, 2.1, 2.2) of the bottle (1) with an external wrapping having several layers (3) and integrating the external part (4.1, 4.4, 4.6, 4.7, 4.9) almost completely in a mass of the bottle (1).

2. The according to claim 1, wherein the internal part (4.2, 4.5, 4.8) is of annular form and extractable, which is configured to be disassembled and reassembled by unscrewing and screwing in order to facilitate maintenance and replacement of the toroidal seal (5) contained therein.

3. The collar according to claim 1, wherein a central portion of the internal part (4.2, 4.5, 4.8) of the nozzle (4) has an internal axially formed seat (9) suitable for receiving a wrench, in order to facilitate locking or disassembly with the respective external part (4.1, 4.4, 4.6, 4.7, 4.9).

4. The collar to claim 1, wherein the external part (4.6) and the internal part (4.5) forming the nozzle (4) have respective internal-external threads in direct contact with an end of the core (2.1), the core being threaded (6) both on the an internal terminal part and on an external terminal part.

5. The collar according to claim 4, wherein the threads both on the external and internal terminal part of the core (2.2) and on the external part (4.7) and the internal part (4.8) of the nozzle (4) are conical (6.1).

6. The collar according to claim 1, wherein the external part (4.9) of the nozzle (4) and the internal part of the nozzle each have at least one grooved seat (7) suitable for receiving an appropriate toroidal seal (5) positioned to be in contact with the core (2, 2.1, 2.2).

7. A collar for high-pressure bottles, preferably implemented with an internal core (2) made of a sheet of metallic or plastic material and lined on the outside with several layers of reinforcement fibers and resins, the collar comprising:
an internal part (4.3) and an external part (4.4) configured to be attached to each other forming a nozzle (4), the internal part (4.3) being in the form of a cylindrical ring, whose upper portion has an external thread for being screwed to the external part (4.4) and an internal thread for being screwed to a supply valve or tap, the external part (4.4) having a first upper portion in the form of a cylindrical ring and terminating at a lower end in a broadened manner in a circular inclined and connected flange, which ahs on an upper internal portion a thread configured to be screwed to the thread formed on the internal part (4.3);
wherein the external part (4.4) and the internal part (4.3) are formed of metallic material and define, when coupling of the internal and external parts has taken place, a space sufficient for enclosing, containing and locking between them the core (2) of a bottle (1);
wherein the internal part (4.3) has at least one seat or annular groove (7) on a surface in contact with the core (2) of the bottle (1), suitable for receiving a toroidal seal (5);
wherein the external part (4.4) is further locked to the core (2) of the bottle (1) with an external wrapping having several layers (3) and integrating the external part (4.4) almost completely in a mass of the bottle (1); and
wherein the internal element (4.3) of the nozzle (4) cannot be extracted through the central opening by being of a flared shaped in the internal part that enlarges circumferentially and that has at least two seats (7) for containing seals (5), one on a cylindrical part and one on an enlarged part of the internal element, the seals coming in direct contact with the core (2) of the bottle (1).

8. The collar according to claim 7, wherein in a central lower part of the external part (4.1, 4.4, 4.6, 4.7, 4.9), there is provided a polygonal configuration (8), such to make available more surface resistant to axial rotation after wrapping with the several layers (3) comprising reinforcement fibers and resin.

9. A method for fixing a collar according to claim 1 to the body of a bottle (1) produced using composite materials, comprising:
inserting the seal (5) in the corresponding seat or annular groove (7) formed in the internal part (4.2, 4.5, 4.8), or inserting a respective seal (5) in a respective corresponding seat or annular groove (7) formed in the internal part (4.2, 4.5, 4.8) and the external part (4.1, 4.4, 4.6, 4.7, 4.9);
placing the internal part (4.2, 4.5, 4.8) in adherence on an internal portion of a terminal part of the core (2, 2.1, 2.2) of the bottle (1);
screwing the external part (4.1, 4.4, 4.6, 4.7, 4.9) onto the internal part (4.2, 4.5, 4.8), thereby locking the terminal part of the core (2, 2.1, 2.2); and
wrapping the external part (4.1, 4.4, 4.6, 4.7, 4.9) of the nozzle (4) with the several layers (3) comprising reinforcement fibers and resin during a final construction step of the entire bottle (1), the bottle being of a lightweight type and obtained by wrapping the core (2, 2.1, 2.2) with a composite material.

10. The collar according to claim 1, wherein the several layers comprise reinforcement fibers and a resin.

11. The collar according to claim 1, wherein in a central lower part of the external part (4.1, 4.4, 4.6, 4.7, 4.9), there is provided a polygonal configuration (8), such to make available more surface resistant to axial rotation after wrapping with the several layers (3) comprising reinforcement fibers and resin.

12. The collar according to claim 7, wherein the several layers comprise reinforcement fibers and a resin.

13. A method for fixing a collar according to claim 7 to the body of a bottle (1) produced using composite materials, comprising:
inserting the seal (5) in the corresponding seat or annular groove (7) formed in the internal part (4.2, 4.5, 4.8), or inserting a respective seal (5) in a respective corresponding seat or annular groove (7) formed in the internal part (4.2, 4.5, 4.8) and the external part (4.1, 4.4, 4.6, 4.7, 4.9);
placing the internal part (4.2, 4.5, 4.8) in adherence on an internal portion of a terminal part of the core (2, 2.1, 2.2) of the bottle (1);
screwing the external part (4.1, 4.4, 4.6, 4.7, 4.9) onto the internal part (4.2, 4.5, 4.8), thereby locking the terminal part of the core (2, 2.1, 2.2); and
wrapping the external part (4.1, 4.4, 4.6, 4.7, 4.9) of the nozzle (4) with the several layers (3) comprising reinforcement fibers and resin during a final construction step of the entire bottle (1), the bottle being of a lightweight type and obtained by wrapping the core (2, 2.1, 2.2) with a composite material.
